(19) United States
(12) Patent Application Publication
(10) Pub. No.: US 2014/0102398 A1
(43) Pub. Date: Apr. 17, 2014

(54) DRIVE SYSTEM FOR A VEHICLE

(71) Applicant: ZF FRIEDRICHSHAFEN AG, Friedrichshafen (DE)

(72) Inventors: Andreas Orlamünder, Schonungen (DE); Daniel Lorenz, Bad Kissingen (DE); Michael Kühner, Heilbronn (DE); Thomas Dögel, Nudlingen (DE)

(73) Assignee: ZF FRIEDRICHSHAFEN AG, Friedrichshafen (DE)

(21) Appl. No.: 14/124,200

(22) PCT Filed: May 9, 2012
(86) PCT No.: PCT/EP2012/058560

§ 371 Date: Dec. 5, 2013

(30) Foreign Application Priority Data
Jun. 7, 2011 (DE) 10 2011 077 120.4
Apr. 10, 2012 (DE) 10 2012 205 792.7

(51) Int. Cl. F02B 75/06

(52) U.S. Cl. CPC F16D 3/12
USPC 123/192.1

(57) ABSTRACT

A drive system for a vehicle comprises an internal combustion engine switchable between operating modes of different performance capability, and a torsional vibration damping arrangement that comprises a primary side preferably coupled to a crankshaft and a secondary side rotatable with respect to the primary side against the action of a damper element arrangement. The damper element arrangement has a stiffness which increases as the load torque to be transmitted increases, and the primary side and the secondary side are in a limiting relative rotational position with respect to one another during transmission of a maximum torque which can be delivered in an operating mode with lower performance capability at a maximum torque rotational speed, and the damper element arrangement provides a limiting stiffness in the limiting relative rotational position such that a natural frequency of the torsional vibration damping arrangement is below the maximum torque speed.

### CROSS-REFERENCE TO RELATED APPLICATIONS

This is a U.S. national stage of application No. PCT/EP2012/058560, filed on 9 May 2012, which claims priority to the German Application Nos. 10 2011 077 120.4, filed 7 Jun. 2011 and 10 2012 205 792.7, filed 10 Apr. 2012, the content of all three incorporated herein by reference.

### BACKGROUND OF THE INVENTION

1. Field of the Invention

The present invention is directed to a drive system for a vehicle comprising an internal combustion engine and a torsional vibration damping arrangement, in which the internal combustion engine is switchable between operating modes of different performance capability.

2. Related Art

A drive system, shown schematically in FIG. 1, comprises an internal combustion engine 5, which delivers an unsteady torque owing to the periodic combustion process. Accordingly, a disturbance torque with fixed orders is superposed on the nominal torque. These orders depend on the combustion process (two-cycle or four-cycle process) and on the number of cylinders. Thus the main exciting order of a four-cylinder four-cycle engine is the second order, that of a three-cylinder four-cycle engine is the 1.5th order, and that of a four-cylinder two-cycle engine is the second order.

The system has a control device 2, which detects the load condition and rotational speed at the engine based on signals, e.g., vehicle speed, from the engine or from the rest of the drivetrain 3 (gearbox, differential, axle), whereupon it chooses whether all of the cylinders or only some of the cylinders are to be operated or which combustion process is to be used in the engine; that is, generally speaking, it chooses between operating modes of different performance capability.

In order to stabilize the drivetrain, vibration reducing systems 4, which are configured, e.g., based on the excitation order, are used as torsional vibration damping arrangements. For this purpose, it was possible heretofore to proceed from fixed orders which were not variable during operation.

For the purpose of reducing consumption and therefore also emissions, it is possible to change the quantity of cylinders or the combustion process, i.e., the operating mode, during operation. An internal combustion engine always has its optimal efficiency at a relatively high load so that the specific fuel consumption is lowest at that time. The common partial load states in real operation consume too much fuel in relation to the demanded power.

One solution to this problem is to switch off individual cylinders 1 and operate the rest of the cylinders at a higher load level and, therefore, at a higher level of efficiency. This switching off can be carried out, for example, by turning off the fuel injection for half of the cylinders and/or changing the control times via a variable valve control.

As an alternative solution to switching off cylinders, a four-cycle engine can be optimally configured for partial load operation and can be switched to two-cycle operation at peak load when needed.

Particularly in the cycle relevant for consumption, only loads which are very small in relation to the full engine are demanded; thus in the NEDC (New European Driving Cycle) the engine with an installed power of up to 200 kW only puts out approximately 10 kW because the required accelerations are very moderate. Also, for routine operation of a vehicle the full load is requested only in rare cases so that switching off cylinders or switching operating modes offers a great savings potential.

When the excitation order changes, the distance with respect to rotational speed or frequency between the operating range and the natural frequency of the vibration reducing system also changes and, therefore, so does the quality of vibration reduction.

### SUMMARY OF THE INVENTION

It is the object of the present invention to design a drive system in such a way that a good vibration reduction quality is constantly ensured with varying excitation behavior during operation.

This object is met according to the invention by a drive system according to the independent claim.

Further advantageous constructional variants are indicated in the subclaims.

### BRIEF DESCRIPTION OF DRAWINGS

The invention will be described in more detail in the following with reference to the accompanying drawings. In the drawings:

FIG. 1 is a schematic depiction of a drive system;

FIG. 2 consist of Views 2a), 2b) and 2c) in which View 2a) is a diagram of the torque which can be delivered by the internal combustion engine in an operating mode with maximum performance capability and an operating mode with reduced performance capability, plotted over the rotational speed;

View 2b) is a diagram of an angle-torque characteristic of a torsional vibration damping arrangement with unfavorably configured characteristic;

View 2c) is a diagram of the transfer function of the torsional vibration damping arrangement with the resonances of two damper stages, plotted over the rotational speed;

FIG. 3 consist of Views 3a), 3b) and 3c) in which View 3a) is a view corresponding to View 2a);

View 3b) is a diagram of a characteristic of a torsional vibration damping arrangement corresponding to View 2b) but with favorably configured characteristic;

View 3c) is a graph corresponding to View 2c) showing the transfer functions for a favorably configured characteristic;

FIG. 4 is a diagram showing the transfer function of a speed-adaptive mass damper, plotted over rotational speed;

FIG. 5 shows, in views a) to d) corresponding to FIG. 3, the torque curve, characteristic curve and transfer functions for a favorably configured characteristic in an operating mode with higher performance capability and an operating mode with lower performance capability;

FIG. 6. is a diagram illustrating various examples of stiffness configuration in a torsional vibration damping arrangement depending on the torque to be transmitted;

FIG. 7 is a diagram showing a characteristic curve corresponding to View 5c) of FIG. 5;

FIG. 8 is a diagram showing a continuous, progressively increasing characteristic curve;

FIG. 9 is a schematic representation of a torsional vibration damping arrangement;

FIG. 10 is a constructional embodiment of a torsional vibration damping arrangement in longitudinal section; and

FIG. 11 is a schematic depiction of the integration of a torsional vibration damping arrangement in a hydrodynamic torque converter.

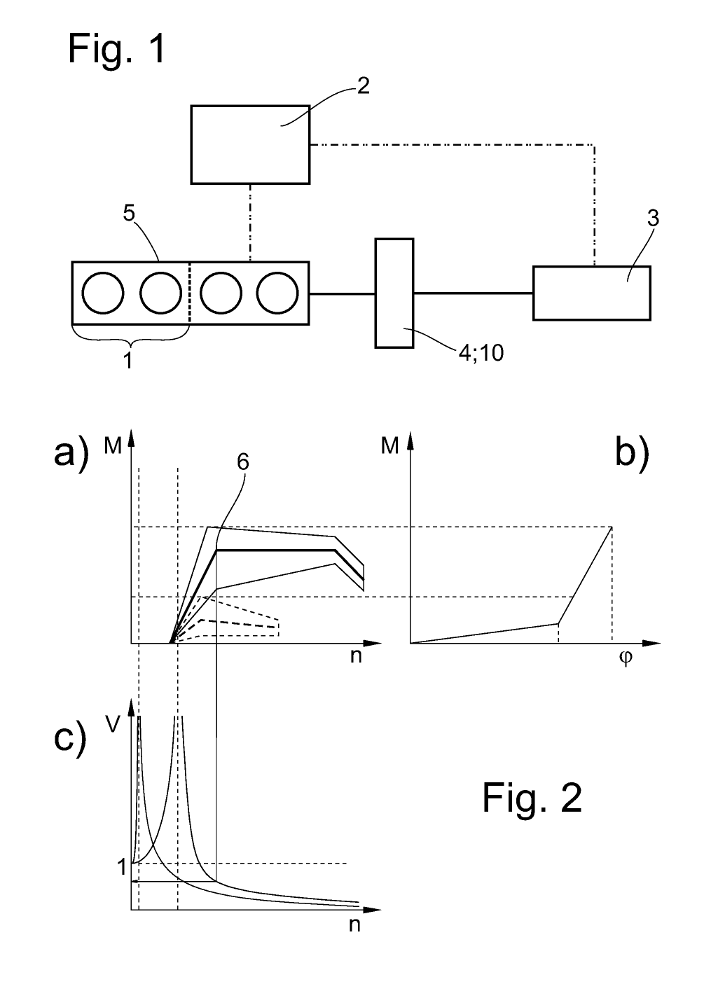

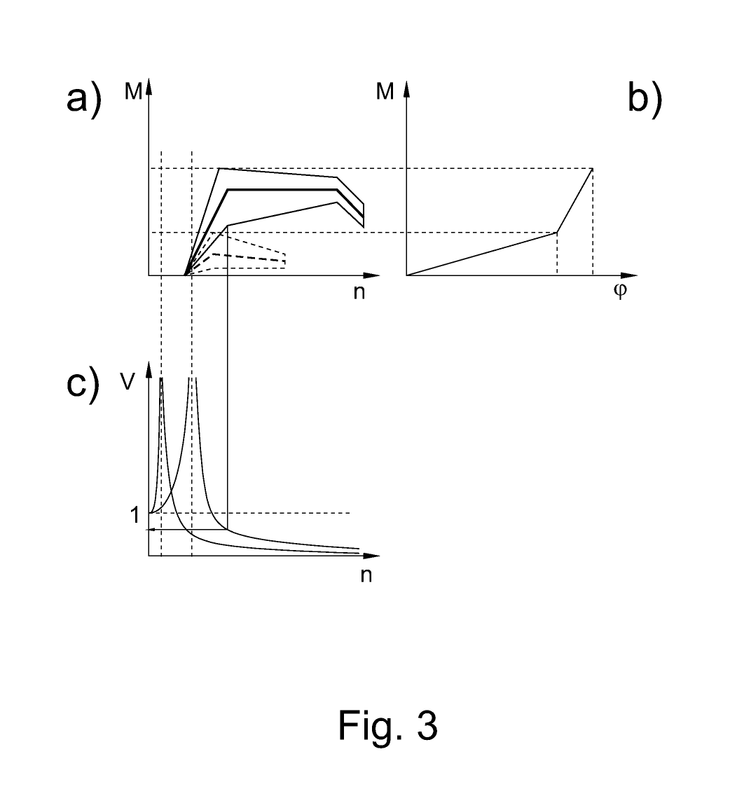

### DETAILED DESCRIPTION OF THE PRESENTLY PREFERRED EMBODIMENTS

A lowpass filter passes the torque having a low frequency or order (e.g., ideally only the nominal torque of zeroeth order) and blocks the alternating higher-order or higher-frequency torques. This is realized by means of a vibratory dual mass flywheel (DMF) with a primary side and a secondary side which is rotatable with respect to the primary side against the action of a damper element arrangement, e.g., spring arrangement, and which has a natural frequency at which the system can execute very high angular deflections when this natural frequency is excited. At best, this means annoying noise and at worst that the system will be destroyed. Therefore, the systems are so designed with respect to their mass-stiffness ratios that this natural frequency lies far below the idling speed and, therefore, the operating rotational speed range. For example, the natural frequency of a dual mass flywheel is approximately 750/min.

When this dual mass flywheel is operated in a four-cylinder four-cycle engine, the lowest excitation frequency at an idling speed of 750/min through the second order as main exciting order is at approximately 1600/min, i.e., far above the resonance of the dual mass flywheel. This makes use of the fact that far above the resonance the amplitudes are smaller downstream of the system than upstream of the system because of the transfer function. The dual mass flywheel decouples and reduces the excitation that is conveyed to the rest of the drivetrain, e.g., the gearbox, and which can lead to noise.

If the quantity of cylinders in this engine is halved, the main exciting order is also halved from the second order to the first order. Accordingly, the lowest excitation frequency at an idling speed of 750/min is at 800/min and, therefore, in the range of the resonant frequency of the dual mass flywheel. The amplitudes are very high and the system does not decouple.

While the solution of increasing the idling speed in switch-off operation is reasonable with respect to engine dynamics, it has the disadvantage that the speed-proportional hydrodynamic losses increase and the engine is no longer operated in the range of optimum efficiency. For this reason, the vibration reducing system must be specially tuned.

FIG. 2, consisting of connected Views 2a), 2b) and 2c), shows how a conventional design of a torsional vibration damping arrangement, e.g., dual mass flywheel, affects the behavior when cylinders are switched off. View 2b) shows a progressive torque-angle characteristic having a kink where the stiffness increases sharply. The first stage is an idling stage or low load stage, for example. The characteristic is substantially linear in the two characteristic curve segments below and above the kink.

In View 2a), the solid bold line represents the nominal torque of a four-cylinder engine over rotational speed. The enveloping solid thin lines show the amplitudes of the superposed alternating torque and accordingly represent the maximum and minimum torque, respectively. Comparison with the characteristic of the dual mass flywheel shows that the second stage of the dual mass flywheel is active at full load. The solid bold line shows the nominal torque with no cylinders switched off, i.e., in an operating mode with higher or maximum performance capability.

The bold dashed line in View 2a) shows the nominal torque curve of the engine with switched off cylinders in which only two cylinders are operating. Consequently, also only approximately half of the torque is available. A disturbance torque, whose amplitude is shown by the thin dashed enveloping line, is likewise superposed on this nominal torque. Usually, switch-off operation is not applied over the entire rotational speed band of the engine.

However, as a result of the configuration of the characteristic the soft first stage is not sufficient for the nominal torque in switched-off cylinder operation, so that the dual mass flywheel is operated in its second stage.

The decoupling quality depends in both cases—all-cylinder operation and switch-off operation—on the speed-related distance from the resonance of the dual mass flywheel.

In all-cylinder operation, the dual mass flywheel is still operated supercritically due to the main excitation order (second order). In the transfer function shown in View 2c) it can be seen that the amplitude ratio is less than 1 considering, for example, the rotational speed at position 6 in that the vertical line is dropped at the rotational speed until hitting the transfer function of the second stage.

If cylinders are switched off in the engine, the main exciting order decreases, for example, by half Instead of the second order, the first order is relevant. Therefore, an adaptation of order must be carried out in View 2c); accordingly, at half of the rotational speed, the transfer function of the second stage of the dual mass flywheel is reached close to resonance—even subcritically in this case—at a substantially greater amplitude ratio, which results in an unacceptably poor decoupling quality in spite of the lower torque amplitude in switched-off cylinder operation.

The reason for the poor response is the very flat first stage so that operation takes place in the excessively stiff second stage in switched-off cylinder operation.

One solution consists in making the first stage of the characteristic so stiff that, on the one hand, switched-off cylinder operation always takes place in the first stage and, on the other hand, the stiffness is still small enough that supercritical operation is possible.

It is clear from View 3b) that the stiffness was maintained in the second stage, which ensures a good decoupling at full load in all-cylinder operation, while the second stage was adapted to be stiffer than in FIG. 2 so that switch-off operation can always take place in this first stage.

In this way, a transfer function of <1 and, therefore, a decoupling of vibrations is achieved even after adapting the order for switch-off operation.

A deflection mass oscillating unit, referred to generally as a mass damper, comprises a mass as dynamic energy accumulator and a stiffness as static energy accumulator. Its natural frequency is tuned such that, when excited, the structural component to which the mass damper is connected does not undergo deflection.

The stiffness may be constant, resulting in a fixed-frequency mass damper, or may be speed-dependent resulting in an order damper, also known as a speed-adaptive damper. A fixed-frequency mass damper only damps a fixed frequency, while the order damper damps an order.

Order dampers in the form of centrifugal pendulums which are designed to absorb the main exciting orders are particularly common in motor vehicles. It was mentioned above that the main exciting order changes when switching off cylinders or switching combustion processes or, generally speaking, when the operating mode changes. In view of this fact, an individual mass damper cannot stabilize the drivetrain. There is even a risk that because of its two natural frequencies the mass damper will exacerbate resonances if an “incorrect” excitation order is applied.

One solution consists in installing a specifically tuned mass damper for every possible order.

For this purpose, individual mass dampers must be installed for all orders that occur or for all critical orders. In case of the four-cylinder engine which is reduced to a two-cylinder engine, a mass damper tuned to the second order and the first order would be required.

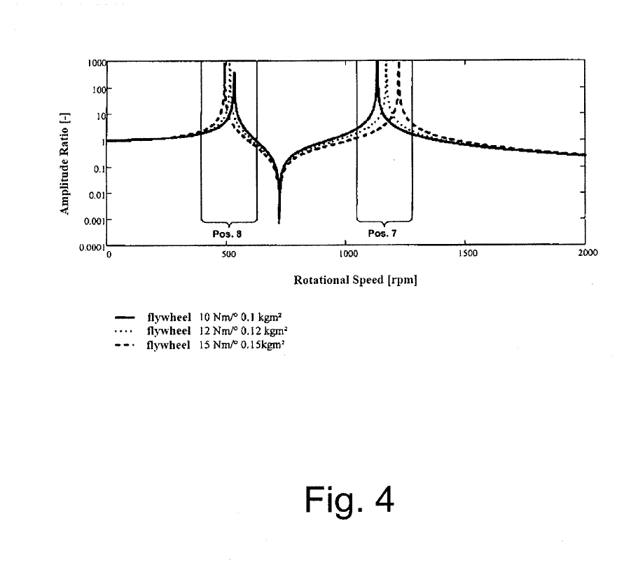

As is shown in FIG. 4, a mass damper has, besides its mass damper frequency, two natural frequencies in which its amplitude can be very large. The distance between these natural frequencies and the damper frequency with respect to rotational speed depends on the ratio of mass to mass moment of inertia. The greater the inertia of the mass damper, the greater the distance. Naturally, it must be taken into consideration in this regard that the stiffness must be adapted to the mass or to the mass moment of inertia in order to maintain the damper frequency or damper order. The ratio of stiffness to mass must remain equal.

An order damper, e.g., a centrifugal pendulum (speed-adaptive damper), exhibits the same behavior when the order rather than the frequency is plotted on the abscissa.

As regards switching off cylinders, this means that when the excitation order is halved exactly one of the lower resonances or resonant orders of the mass damper can be affected, which can lead to the destruction of the mass damper or to excitation of vibrations by the mass damper.

The solution consists in that the inertia of the damper mass is either less than, e.g., 90%, preferably 75%, at most preferably 50%, of the flywheel, generally a flywheel mass arrangement, in order to remain appreciably below the lower damper resonance when reducing the order, or appreciably greater than 110%, preferably 150%, at most preferably 200%, in order to remain operating above the damper resonance in switching operation.

Often, the value of 200% is difficult to adjust for reasons relating to installation space and weight, while the value of 50% is limited by the energy accumulator capability of the mass damper; in particular, a speed-adaptive damper requires a sufficiently large mass because it derives its stiffness from the centrifugal force.

The behavior shown in FIG. 4 applies to any mass damper that is used with its specific damper frequency or damper order in the vibration reducing system.

Further, the set of problems described above also applies to the opposite case. For example, if a mass damper tuned to the second order and a mass damper tuned to the first order are used in a four-cylinder engine, the mass damper of the first order which is to work for switch-off operation (two-cylinder operation) runs the risk that its upper resonant frequency or resonant order in four-cylinder operation is affected precisely by the main exciting order. Accordingly, a sufficiently large frequency distance or order distance must also be ensured in this case by a suitable mass or mass moment of inertia (e.g., <50% or >>200%). Accordingly, it must be ensured when configuring the orders or frequencies for the mass damper for all-cylinder operation and switch-off operation that the frequency ranges or order ranges at position 7 and at position 8 of all of the mass dampers are not affected.

With respect to the mass damper, it is possible in particular to carry out a good preliminary decoupling beforehand by means of a lowpass filter, e.g., a dual mass flywheel, so that the remaining residual alternating torque which has a very small amplitude is compensated by the mass damper. Accordingly, mass dampers having a small mass and, therefore, a limited ability to absorb energy are also capable of ensuring sufficient comfort in both operating states.

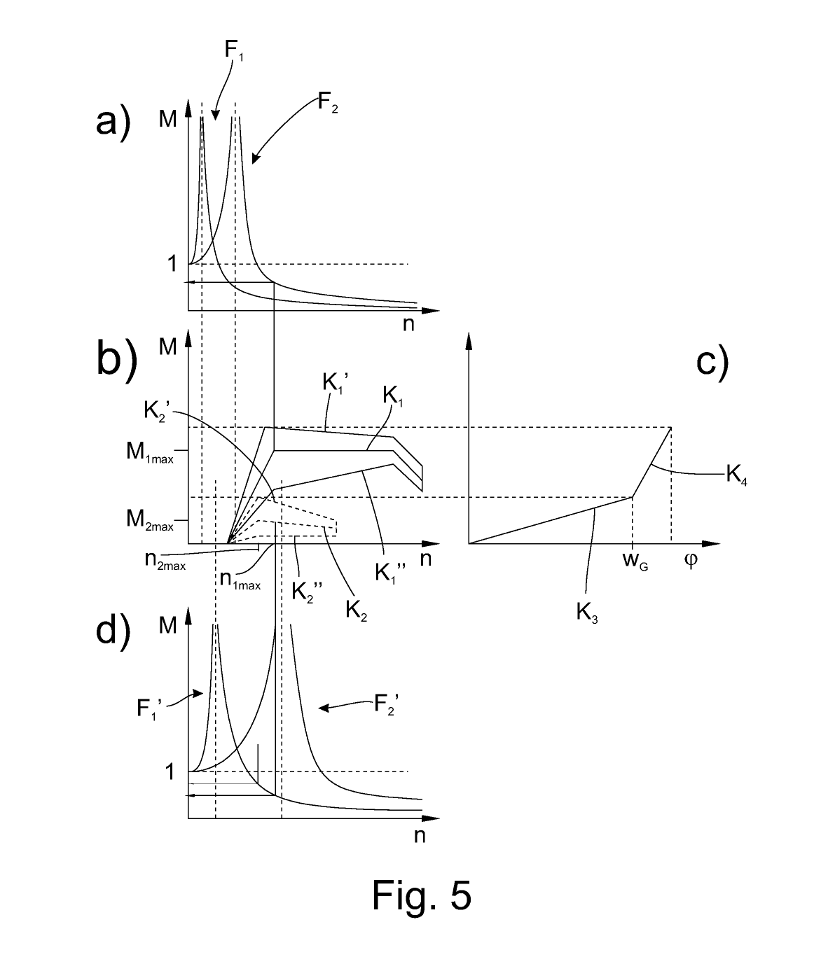

The configuration of a torsional vibration damping arrangement according to the invention with a primary side and a secondary side which is rotatable relative to the primary side against the action of a damper element arrangement, i.e., constructed, for example, in the manner of a dual mass flywheel, will be described once again in detail in the following referring to FIGS. 5 to 12.

In View 5b) of FIG. 5, curve K₁ which is plotted over the rotational speed n of the internal combustion engine 5 represents the torque delivered by the internal combustion engine 5 or the maximum torque which can be delivered by the latter for a respective rotational speed. At a maximum torque rotational speed n₁ₘₐₓ, the internal combustion engine 5 in the operating mode with the highest performance capability, i.e., when all of the cylinders are operating, delivers the maximum nominal torque Mₘₐₓ when a high load torque of this kind is demanded, for example, by corresponding actuation of an accelerator pedal. The enveloping curves K₁′ and K₁″ illustrate the torque range of the torque characteristic K₁ in which the torque varies by means of superposing an oscillating component in the event of rotational irregularities, for example, torsional vibrations.

Curve K₂ shows the torque curve for an operating mode with lower performance capacity, for example, an operating mode in which one half of the cylinders of the internal combustion engine 5 are switched off. At a somewhat lower maximum torque rotational speed n₂ₘₐₓ, the internal combustion engine 5 can deliver a maximum nominal torque M₂ₘₐₓ with a corresponding demand for load torque. Here also there exists a range, bounded by characteristic curves K₂′ and K₂″, in which the torque can vary in the operating mode with lower performance capability.

View 5c) shows the angle-torque characteristic of a torsional vibration damping arrangement, for example, a dual mass flywheel, with two characteristic curve segments K₃ and K₄. A first damper stage with the flatter characteristic curve segment K₃ substantially operates up to a limiting relative rotational angle W_{G}. A second damper stage with the steeper characteristic curve segment K₄ essentially operates above the limiting rotational angle W_{G}. This means that in the first damper stage the torsional vibration damping arrangement has a lower stiffness, represented by a smaller spring constant, than in the second damper stage. The transition between the two damper stages or spring stages, i.e., the limiting relative rotational angle W_{G}, is selected in such a way that in the operating mode with lower performance capability the maximum transmissible maximum torque, i.e., the maximum nominal torque M₂ₘₐₓ plus the torque component added as a result of rotational irregularities, can still be transmitted by the first damper stage or spring stage, i.e., in characteristic curve segment K₃. The second damper stage or spring stage with characteristic K₄ only takes effect when the load torque to be transmitted is still higher, which, as a matter of principle, can only be the case in the operating mode with higher or maximum performance capability.

For the state in which the internal combustion engine 5 is operated in the operating mode with greater or maximum performance capability, View 5a) represents the transfer function F₁ for the first, i.e., less stiff, damper stage and the transfer function F₂ for the second, i.e., stiffer, damper stage. Since the second order is considered to be the critical excitation order in a four-cycle engine, the rotational speed scale is halved. Considering, for example, the maximum torque rotational speed n₁ₘₐₓ with respect to the second order, this means that transfer function F₂ is to be considered at a frequency or rotational speed that corresponds to twice the rotational speed n₁ₘₐₓ. At this rotational speed, the transfer function which is represented by curve F₂ has a value considerably less than 1, which shows that at the secondary side, i.e., in the output region of the torsional vibration damping arrangement, rotational irregularities are appreciably reduced with respect to the primary side and in the input region. It should be noted that, generally speaking, the transfer functions F₁ and F₂ generally represent the amplitude ratio of output rotational irregularity to input rotational irregularity, represented, for example, by the rotational acceleration, rotational angle speed, rotational angle or torque. If this transfer function has a value of 1, no damping takes place; at values greater than 1, there is an increase in vibrations which can be at a maximum in the region of resonance; and at values below 1 a damping of vibrations take place.

View 5b) of FIG. 5 illustrates the transfer functions F₁′ and F₂′ for the two damper stages or spring stages for the operating mode with lower performance capability, i.e., for example, when half of the cylinders are switched off. Since the second damping stage with characteristic curve segment K₄ can no longer be active as a matter of principle due to the characteristic configuration shown in View 5c) in the operating mode with lower performance capability, transfer function F₂′ is irrelevant. Thus the fact that its resonance lies very close to the maximum torque rotational speed n₂ₘₐₓ may be disregarded.

It should be noted here that there is no need for adapting the scaling of the rotational speed in View 5d) due to the fact that when half of the cylinders are switched off it is the first order and not the second order that is considered particularly critical with respect to the excitation of vibrations.

It will be seen in View 5d) that when the maximum torque which corresponds to the maximum nominal torque M₂ₘₐₓ plus the torque component added as a result of the excitation of vibrations is delivered in the operating mode with lower performance capability, the transfer function F₁′, i.e., the ratio of a vibration quantity at the output side or secondary side to a vibration quantity at the primary side or input region, is appreciably less than 1. This means that a sufficient distance from the resonance of the transfer function F₁′ can also be ensured in the operating mode with lower performance capability for all of the load torques to be transmitted. It can advantageously be provided by means of the configuration of the stiffnesses or mass ratios that in each operating mode the expected operating rotational speed range is greater by a factor of 2^{0.5} than the respective resonance of the transfer function to be taken into account.

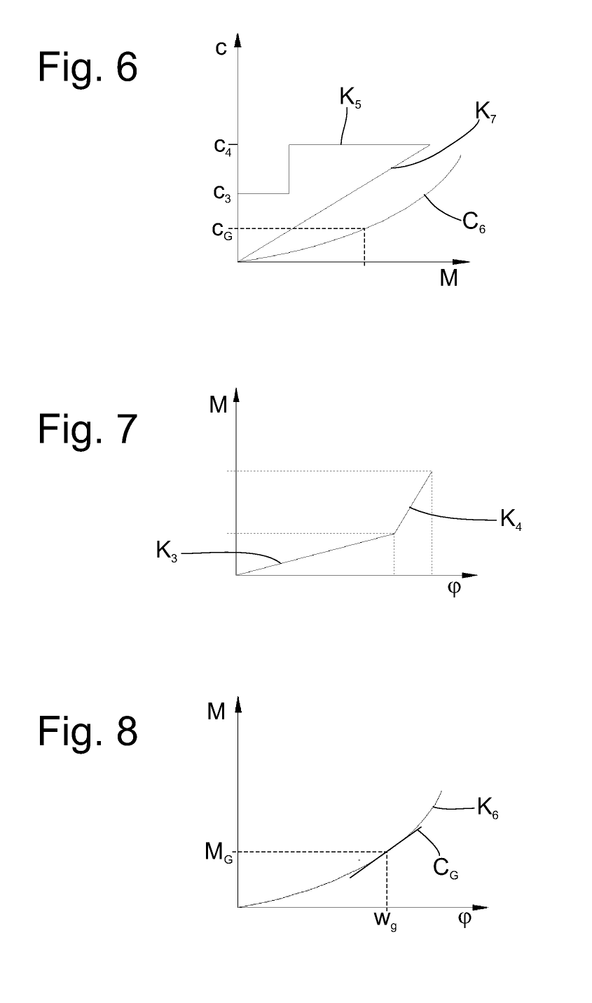

The various constructional variants of the torsional vibration damping arrangement with respect to the configuration of stiffness thereof are illustrated in FIGS. 6 to 8. Accordingly, FIG. 6 shows the curve of the angle-torque characteristic with characteristic curve segments K₃ and K₄ which has already been described. In FIG. 6, this curve is represented by a stepped curve K₅ which illustrates a stiffness c₃ represented in characteristic curve segment K₃ by the slope of characteristic curve segment K₃ and a greater stiffness c₄ in characteristic curve segment K₄.

The characteristic K₆ plotted in FIG. 8 represents a progressively increasing stiffness which is represented in the graph in FIG. 6 by a correspondingly progressively increasing stiffness curve c₆. In FIG. 8, the angle W_{G} represents the limiting relative rotational angle which is associated with a limiting stiffness c_{G}. This is expressed by the slope of a tangent line at characteristic curve K₆ at the limiting relative rotational angle. This limiting relative rotational angle W_{G} identifies a load torque M_{G} which can correspond, for example, to the maximum torque (nominal torque+vibration component) that can be delivered in the operating mode with lower performance capability, i.e., which is to be transmitted via the torsional vibration damping arrangement. This means that the limiting stiffness is the stiffness which can still be used in the operating mode with lower performance capability by the maximum load torque that can be delivered or is to be transmitted, respectively, in this operating mode. Through the configuration of the damper element arrangement of the torsional vibration damping arrangement it can also be provided that the resonance of the transfer function, as is illustrated in View 5d), is sufficiently far below the maximum torque rotational speed to ensure that the transfer function has a value appreciably below 1 at this rotational speed.

In FIG. 6, a curve K₇ illustrates a stiffness which likewise increases, linearly in this case, over the applied load torque, and the rate of change of this stiffness is selected such that when the limiting relative rotational angle is reached there is a corresponding limiting stiffness at the same time. In case of a stepped stiffness characteristic K₅, this corresponds to the limiting stiffness in the damper stage or spring stage with characteristic curve segment K₃ with the stiffness or spring constant c₃ effective therein.

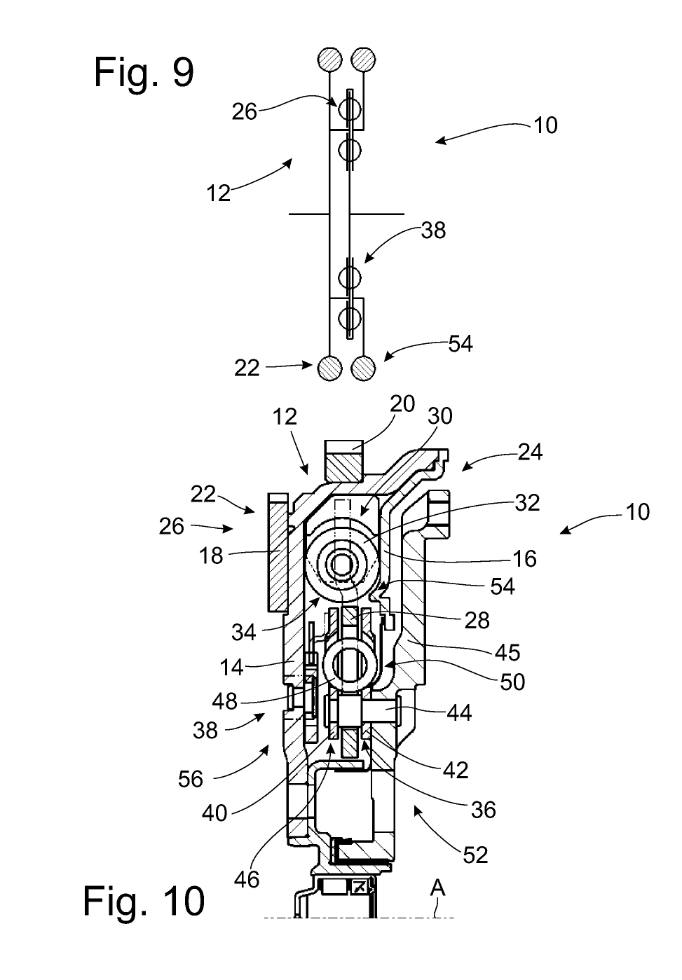

A torsional vibration damping arrangement with two damper stages or spring stages will be described in the following with reference to FIGS. 9 and 10 based on the schematic illustration in FIG. 9 and on the constructional arrangement in FIG. 10.

The torsional vibration damping arrangement 10 comprises an input region 12 which is to be connected, for example, to the crankshaft of the internal combustion engine 5 and which comprises two cover disk elements 14 and 16 in the constructional arrangement. These two cover disk elements 14 and 16, together with one or more mass parts 18 provided at the latter and a starter ring gear 20, essentially provide an input-side flywheel mass 22.

In this connection, the cover disk elements 14, 16 substantially also form the primary side 24 of a damper stage 26, which is located farther radially outward in this embodiment example.

A central disk element 28 is located axially between the two cover disk elements 14, 16. The radially outer area of this central disk element 28 substantially provides a secondary side 30 of the damper stage 26. The springs 32 of a spring stage 34 associated with the damper stage 26 are supported at the central disk element 28 and the cover disk elements 14, 16. The primary side 24 and the secondary side 30 can rotate relative to one another around an axis of rotation A through compression of these springs 32. The radially inner area of the central disk element 28 forms the primary side 36 for a damper stage 38 located farther radially inward. At that location, two additional cover disk elements 40, 42 are located axially on both sides of the central disk element 28 and are fixedly connected by rivets 44 to a flywheel 45 and essentially provide the secondary side 46 of the damper stage 38.

The springs 48 of a spring stage 50 associated with the damper stage 38 are supported at the central disk element 28 and the additional cover disk elements 40, 42. The primary side 36 and secondary side 46 of the second damper stage 38 can rotate relative to one another around an axis of rotation A through compression of these springs 48.

The flywheel 45 together with the additional cover disk elements 40, 42 essentially forms an output-side flywheel mass 52, while the central disk element 28 essentially provides an intermediate mass 54 located between the two damper stages 26, 38.

With the construction which is shown schematically in FIG. 9 and in a constructional embodiment in FIG. 10 and in which the primary side 24 of the radially outer damper stage 26 substantially also provides the primary side of the torsional vibration damping arrangement 10 and the secondary side 46 of the radially inner damper stage 38 essentially also provides the secondary side of the torsional vibration damping arrangement 10, the two spring stages 34, 50 with their respective springs 32, 48 generally form the damper element arrangement 56 whose stiffness can be configured in the manner shown above. In other words, by means of a corresponding configuration or design of the springs 48, the damper stage 38, for example, which is located farther inward structurally and accordingly has smaller dimensions could provide the characteristic curve segment K₃ in View 5c). Through configuration of the springs 32, the damper stage 34 which is located farther outward radially and which accordingly also has smaller structural dimensions could provide the characteristic curve segment K₄ in View 5c). Of course, each of the damper stages 26, 38 could also be formed, per se, with a stepped characteristic curve by means of a corresponding arrangement of a plurality of springs acting in series or in parallel so that the curve in View 5c) can basically also be realized when a damper element arrangement is provided which has only one spring stage, i.e., in the construction of the torsional vibration damping arrangement 10 with only one damper stage.

In a construction of this kind, for example, the embodiment shown in FIG. 6 and FIG. 8 having continuously increasing stiffness or spring constant increasing either linearly or progressively could also be realized. This can be achieved, for example, by means of coil compression springs with variable pitch or variable coil diameter. The progressively increasing curve shown by curve K₆ or C₆ can also be at least approximated by a plurality of serially acting spring stages with linear characteristic.

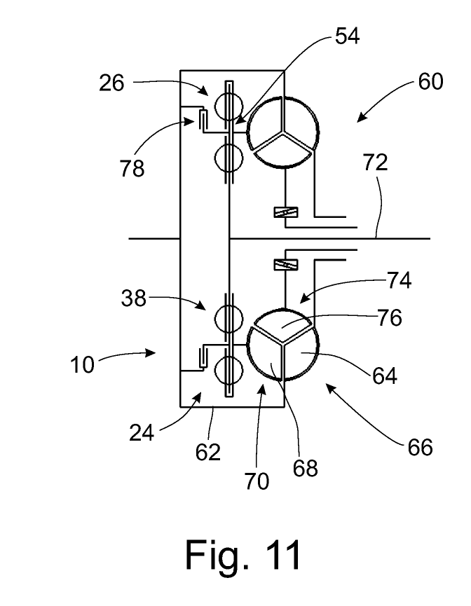

FIG. 11 shows the integration of a torsional vibration damping arrangement 10 of this kind in a starting element, in this case, for example, a hydrodynamic torque converter 60. Its housing 62 is to be connected to the crankshaft of the internal combustion engine 5 and, along with impeller blades 64, provides an input-side impeller 66. Provided in the interior of the housing which is generally filled with fluid is a turbine 70 which is provided with turbine blades 68 and which is coupled to a transmission input shaft 72 via the torsional vibration damping arrangement 10 and the damper stage 38 located farther radially inward. A stator 74 with stator blades 76 is located between the impeller 66 and the turbine 70.

The input region or primary side 24 of the torsional vibration damping arrangement 10 can be coupled to the housing via a lockup clutch, designated generally by 78, so that the torque is transmitted in series via the two damper stages 26, 38 to the transmission input shaft 72 when the lockup clutch 78 is engaged. In this state, in which the hydrodynamic circuit formed between the impeller 66, turbine 70 and stator 74 is inactive, the impeller 70 helps to increase the intermediate mass 54. When the lockup clutch is released, the torque is transmitted via impeller 66 and turbine 70 to the intermediate mass 54 and the second damper stage 38 and from the latter to the transmission input shaft 72.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A drive system for a vehicle, comprising:
an internal combustion engine (5); and
a torsional vibration damping arrangement (10),
wherein the internal combustion engine (5) is switchable between operating modes of different performance capability, and wherein the torsional vibration damping arrangement (10) comprises a primary side (24, 36) coupled to a crankshaft and a secondary side (30, 46) rotatable with respect to the primary side (24, 36) against the action of a damper element arrangement (34, 50),
wherein the damper element arrangement (34, 50) has a stiffness that increases as the load torque to be transmitted increases,
wherein the primary side (24, 36) and the secondary side (30, 46) are in a limiting relative rotational position (WG) with respect to one another during transmission of a maximum torque which can be delivered in an operating mode with lower performance capability at a maximum torque rotational speed (n2max), and
wherein the damper element arrangement (34, 50) provides a limiting stiffness in the limiting relative rotational position (WG) such that a natural frequency of the torsional vibration damping arrangement (10) is below the maximum torque rotational speed (n2max).

17. The drive system according to claim 16, wherein the ratio of a vibration quantity at the secondary side (30, 46) to a vibration quantity at the primary side (24, 36) is less than 1 during transmission of the maximum torque.

18. The drive system according to claim 16, wherein the stiffness of the damper element arrangement (34, 50) increases linearly at least partially as the load torque increases.

19. The drive system according to claim 16, wherein the stiffness of the damper element arrangement (34, 50) increases progressively at least partially as the load torque increases.

20. The drive system according to claim 16, wherein the damper element arrangement (34, 50) comprises at least two spring stages (34, 50), wherein a first spring stage (50) with lower stiffness acts substantially in a first relative rotational angle region between primary side (24, 36) and secondary side (30, 46) and a second spring stage (34) with greater stiffness acts substantially in a second relative rotational angle region between primary side (24, 36) and secondary side (30, 46), wherein a load torque to be applied for generating a transition from the first rotational angle region to the second rotational angle region corresponds at least to the maximum torque that can be delivered by the internal combustion engine in an operating mode with lower performance capability.

21. The drive system according to claim 16, wherein the operating modes include a first operating state in which all of the cylinders are in operation and at least a second operating state in which only some of the cylinders are in operation.

22. The drive system according to claim 16, wherein the operating modes include a two-cycle operation and a four-cycle operation.

23. The drive system according to claim 16, wherein the torsional vibration damping arrangement further comprises a flywheel mass arrangement and at least one deflection mass pendulum unit with a deflection mass carrier and a deflection mass arrangement supported at the deflection mass carrier such that it can deflect out of a basic relative position with respect to the latter by a deflection mass coupling arrangement.

24. The drive system according to claim 23, wherein at least one deflection mass pendulum unit is formed as a centrifugal mass pendulum unit, wherein a radial distance of the deflection mass arrangement relative to an axis of rotation changes when the deflection mass arrangement is deflected from the basic relative position with respect to the deflection mass carrier.

25. The drive system according to claim 24, wherein at least one guide path with a vertex region is provided at the deflection mass carrier and/or at the deflection mass arrangement, and the deflection mass coupling arrangement comprises a coupling member movable along the guide path, wherein when the deflection mass arrangement is deflected out of the basic relative position the coupling member moves starting from the vertex region of a guide path provided in the deflection mass carrier and/or of a guide path provided in the deflection mass arrangement.

26. The drive system according to claim 23, wherein at least one deflection mass pendulum unit is formed as a spring-mass pendulum unit, wherein the deflection mass coupling arrangement comprises a spring arrangement which is supported or can be supported with respect to the deflection mass carrier and deflection mass arrangement.

27. The drive system according to claim 23, wherein at least one deflection mass pendulum unit comprises:
a deflection mass carrier rotatable around an axis of rotation;
a deflection mass arrangement configured to be deflected in a circumferential direction around the axis of rotation with respect to the deflection mass carrier;
a deformable restoring element configured to be supported in a carrier support region with respect to the deflection mass carrier and in a deflection mass support region with respect to the deflection mass arrangement, wherein a deflection of the deflection mass arrangement out of a basic relative position with respect to the deflection mass carrier in at least one direction causes a deformation of the restoring element; and
a supporting element radially movably supported at the deflection mass carrier and which provides the carrier support region, wherein a distance between the carrier support region and the deflection mass support region is changeable by movement of the supporting element at the deflection mass carrier, and the supporting element is pre-loaded in direction of a radially inner basic position and, starting from the basic position, is displaceable radially outward in opposition to the pre-loading accompanied by centrifugal force when the deflection mass carrier rotates around the axis of rotation.

28. The drive system according to claim 23, wherein a mass moment of inertia of the deflection mass arrangement is either less than 90% of a mass moment of inertia of the flywheel mass arrangement or is greater than 110% of the mass moment of inertia of the flywheel mass arrangement.

29. The drive system according to claim 23, wherein the mass moment of inertia of the deflection mass arrangement is either less than 75% of the mass moment of inertia of the flywheel mass arrangement or is greater than 150% of the mass moment of inertia of the flywheel mass arrangement.

30. The drive system according to claim 23, wherein the torsional vibration damping arrangement provides the deflection mass carrier.

31. The drive system according to claim 23, wherein the mass moment of inertia of the deflection mass arrangement is either less than 50% of the mass moment of inertia of the flywheel mass arrangement or is greater than 200% of the mass moment of inertia of the flywheel mass arrangement.
